(19) United States
(12) Patent Application Publication
(10) Pub. No.: US 2024/0325240 A1
(43) Pub. Date: Oct. 3, 2024

(54) Crossed-finger Swinging Massage Structure and Crossed-finger Swinging Massager

(71) Applicants: Beston (Shenzhen) Technology Co., LTD., ShenZhen (CN); Dongguan Qianmei Intelligent Technology Co.,Ltd., Dongguan (CN)

(72) Inventors: Zhenbo ZHANG, ShenZhen (CN); Qiuhui HE, Dongguan (CN)

(73) Assignees: Beston (Shenzhen) Technology Co., LTD., ShenZhen (CN); Dongguan Qianmei Intelligent Technology Co.,Ltd., Dongguan (CN)

(21) Appl. No.: 18/743,173

(22) Filed: Jun. 14, 2024

(30) Foreign Application Priority Data
Dec. 12, 2023 (CN) 202323395444.3
May 9, 2024 (CN) 202410572837.7

(51) Int. Cl. A61H 19/00; A61H 23/00; A61H 23/02

(52) U.S. Cl. CPC A61H 19/40; A61H 19/34; A61H 23/006; A61H 23/0254; A61H 2201/0153; A61H 2201/149; A61H 2201/1676; A61H 2201/1685

(57) ABSTRACT

A crossed-finger swinging massage structure and a crossed-finger swinging massager are disclosed, the massage structure includes a wand-shaped main body having a hand-held section and a massage section; the massage section is adapted to be plugged into an inner cavity of a hole-shaped part to be massaged; the second plug-in segment is composed of a first finger-shaped arm and a second finger-shaped arm that are symmetrical about an axis N1; and the first finger-shaped arm and the second finger-shaped arm can be controlled by driving force to swing in a crossed manner in the inner cavity of the hole-shaped part to be massaged, so as to produce squeezing or tapping massage effects on a side wall surface of the inner cavity of the hole-shaped part to be massaged.

### CROSS REFERENCE TO RELATED APPLICATIONS

This application is based upon and claims foreign priority to Chinese Patent Application No. CN202323395444.3, filed on Dec. 12, 2023, and CN202410572837.7, filed on May 9, 2024, the entire contents of which are incorporated herein by reference.

### TECHNICAL FIELD

The present disclosure belongs to the field of massagers, relates to technology for improving stimulation effects of the massages, and particularly relates to a crossed-finger swinging massage structure and a crossed-finger swinging massager.

### BACKGROUND

Plug-in massagers are devices designed for being plugged into a body for massage, and are commonly used in medical, healthcare, or personal care fields. The devices are usually designed to be safe and comfortable, and capable of providing therapeutic or relaxing massage targeting specific body parts, such as muscle tissue, internal joints, or specific sensitive areas. The plug-in massagers can have various features such as vibration, heat therapy, electrical stimulation, or other mechanical actions, so as to enhance their effectiveness and user experience.

In the prior art, massage methods of the plug-in massagers are relatively diverse. For example, some devices are each provided with an extendable end on a wand-shaped body, or a massage head attached to the wand-shaped body that is driven to scrape or squeeze an inner cavity of a hole-shaped part to be massaged.

However, massage stimulation effects provided by the aforementioned designs to the inner cavity of the hole-shaped part to be massaged are limited, specifically, the devices tend to cause relatively small degrees of deformation in a wall surface of the inner cavity and can only massage a certain local area of the wall surface of the inner cavity, therefore, a user is unable to feel strong stimulation sensation, failing to meet the needs of the user.

### SUMMARY

In order to solve the above technical problems, the present disclosure provides a crossed-finger swinging massage structure and a crossed-finger swinging massager.

In order to achieve the above objectives, the present disclosure adopts a technical solution as follows:
a crossed-finger swinging massage structure, including:
a wand-shaped main body having a hand-held section and a massage section;
the massage section is adapted to be plugged into an inner cavity of a part to be massaged;
where the massage section comprises a first plug-in segment and a second plug-in segment;
the first plug-in segment is a solid rod-shaped structure;
the second plug-in segment is composed of a first finger-shaped arm and a second finger-shaped arm that are symmetrical about an axis N1;
further, a through gap exists between the first finger-shaped arm and the second finger-shaped arm, such that the first finger-shaped arm and the second finger-shaped arm exhibit a dual-finger structure form;
further, the axis N1 is an axis of the massage section; and
the first finger-shaped arm and the second finger-shaped arm can be controlled by driving force to swing in a crossed manner in the inner cavity of the hole-shaped part to be massaged, so as to produce squeezing or tapping massage effects on a side wall surface of the inner cavity of the hole-shaped part to be massaged.
the first finger-shaped arm has a first massage finger, a first hinge joint, and a first driving end;
the second finger-shaped arm has a second massage finger, a second hinge joint and a second driving end;
a supporting portion;
a cross transmission assembly having an active end, a passive end, and a third hinge joint;
an eccentric drive assembly having a driving rail connection portion and a driving motor; wherein
the first massage finger and the second massage finger are disposed in parallel to form a parallel dual-finger structure;
the first finger-shaped arm and the supporting portion are hinged to the first hinge joint, the second finger-shaped arm and the supporting portion are hinged to the second hinge joint, and the cross transmission assembly and the supporting portion are hinged to the third hinge joint;
the first massage finger can swing around an axis L1 at the first hinge joint, the second massage finger can swing around an axis L2 at the second hinge joint, and the cross transmission assembly can swing around an axis L3 at the third hinge joint;
the axis L1 is coaxial with the axis L2, and the axis L3 is perpendicular to the axis L1;
the first driving end is provided with an eccentric driving rail parallel to the axis L1, and the driving rail connecting portion is movably connected to the eccentric driving rail;
the driving rail connecting portion is disposed at an eccentric position where the driving motor rotates, and the first finger-shaped arm swings around the axis L1 in response to the driving rail connecting portion rotating in an eccentric manner; and
the active end of the cross transmission assembly is connected to the first driving end, and the passive end thereof is connected to the second driving end to form a seesaw reversing transmission structure, such that the first massage finger and the second massage finger swing in a crossed manner.

Preferably, when the first massage finger and the second massage finger are in parallel positions, a circumferential outer surface of the dual-finger structure is an approximately cylindrical structure, and the approximately cylindrical structure is suitable for being plugged into the hole-shaped part to be massaged to produce squeezing or tapping massage effects on the side wall surface of the inner cavity of the hole-shaped part to be massaged.

Preferably, the eccentric driving rail is a waist-shaped groove, and the driving rail connecting portion is a driving handle matching the waist-shaped groove.

Preferably, the eccentric driving rail is a convex guiding rail rib, and the driving rail connection portion is a C-shaped snap fastener in snap-in connection with the convex guiding rail rib.

Preferably, a distance a1 from an end portion of the active end to the third hinge joint is less than a distance a2 from an end portion of the passive end to the third hinge joint.

Preferably, a cross section of the convex guiding rail rib is a T-shaped structure or a cross-shaped structure.

Preferably, the active end and the passive end are C-shaped snap connecting portions, and the first driving end and the second driving end have convex ribs connected to the C-shaped snap connecting portions.

Preferably, a first vibration device is installed inside each of the first finger-shaped arm and the second finger-shaped arm.

The present disclosure further provides a crossed-finger swinging massager, including:
the crossed-finger swinging massage structure according to any one of the above technical solutions; and
an auxiliary massage structure, wherein the auxiliary massage structure is formed by branching the wand-shaped main body of the crossed-finger swinging massage structure, so as to provide massage effects on an outer surface of the hole-shaped part to be massaged.

Preferably, the auxiliary massage structure is a vibrating massage structure, or a negative-pressure sucking massage structure, or a reciprocating movement massage structure.

Preferably, when the auxiliary massage structure is the vibrating massage structure, or the reciprocating movement massage structure, the auxiliary massage structure is equipped with a massage head; and
the massage head has a plurality of massage synapses protruding from a surface of the massage head.

Preferably, the massage synapses are ball-shaped, block-shaped, or strip-shaped.

Preferably, the first massage finger and the second massage finger of the crossed-finger swinging massage structure are bent in a swinging direction; and/or
the first massage finger and the second massage finger of the crossed-finger swinging massage structure are bent in a direction perpendicular to the swinging direction.

Preferably, the wand-shaped main body of the crossed-finger swinging massage structure is a linear wand-shaped main body or an arc-shaped wand-shaped main body.

The present disclosure provides a crossed-finger swinging massage structure and a crossed-finger swinging massager, which have the following beneficial effects:
it can provide a cross-swinging massage form capable of entering the inner cavity of the hole-shaped part to be massaged to cause the wall surface of the inner cavity to be greatly deformed, such that the user can feel stronger stimulation sensation; and the cross-swinging massage form of the first finger-shaped arm and the second finger-shaped arm significantly increases the radial dimension of the second plug-in segment, and the radial dimension is changed dynamically, such that greater squeezing or tapping acting force is exerted on the wall surface of the inner cavity, and stimulation sensation is significantly increased.

### BRIEF DESCRIPTION OF THE DRAWINGS

FIG. 1 is a first perspective view of a crossed-finger swinging massager according to the present disclosure (a first finger-shaped arm and a second finger-shaped arm are in initial positions).

FIG. 2 is a second perspective view of a crossed-finger swinging massager according to the present disclosure (a first finger-shaped arm and a second finger-shaped arm are in a first extreme position).

FIG. 3 is a third perspective view of a crossed-finger swinging massager according to the present disclosure (a first finger-shaped arm and a second finger-shaped arm are in a second extreme position).

FIG. 4 is a perspective view of a crossed-finger swinging massage structure according to the present disclosure.

FIG. 5 is a front view of the structure shown in FIG. 4.

FIG. 6 is a side view of a first finger-shaped arm of a crossed-finger swinging massage structure according to the present disclosure.

FIG. 7 is a side view of a second finger-shaped arm of a crossed-finger swinging massage structure according to the present disclosure.

FIG. 8 is a schematic diagram of assembly of a first finger-shaped arm, a second finger-shaped arm and a supporting portion of a crossed-finger swinging massage structure according to the present disclosure.

FIG. 9 is a front view of the structure shown in FIG. 8.

FIG. 10 is a left view of the structure shown in FIG. 8.

FIG. 11 is a right view of the structure shown in FIG. 8.

FIG. 12 is a sectional view of a first finger-shaped arm of a crossed-finger swinging massage structure according to the present disclosure.

FIG. 13 is a sectional view of a second finger-shaped arm of a crossed-finger swinging massage structure according to the present disclosure.

FIG. 14 is a schematic diagram of assembly of a supporting portion and a cross transmission assembly of a crossed-finger swinging massage structure according to the present disclosure.

FIG. 15 is a perspective view of a cross transmission assembly of a crossed-finger swinging massage structure according to the present disclosure.

FIG. 16 is a structural diagram of a driving motor of a crossed-finger swinging massage structure according to the present disclosure.

FIG. 17 is a perspective view of a C-shaped snap connecting portion and a convex rib of a crossed-finger swinging massage structure according to the present disclosure.

FIG. 18 is a perspective view of a C-shaped snap connecting portion and a convex guiding rail rib of a crossed-finger swinging massage structure according to the present disclosure.

FIG. 19 is a sectional view of the structure shown in FIG. 18.

FIG. 20 is a sectional view of a convex guiding rail rib with a cross-shaped structure of a crossed-finger swinging massage structure according to the present disclosure.

FIG. 21 is a sectional view of a crossed-finger swinging massager equipped with a second vibration device according to the present disclosure.

FIG. 22 is a sectional view of a crossed-finger swinging massager equipped with a negative-pressure sucking massage structure according to the present disclosure.

FIG. 23 is a sectional view of a crossed-finger swinging massager equipped with a reciprocating movement massage structure according to the present disclosure.

FIG. 24 is a schematic diagram of using a crossed-finger swinging massager according to the present disclosure.

### REFERENCE NUMERALS IN THE ACCOMPANYING DRAWINGS

1. wand-shaped main body; 101. hand-held section; 102. massage section; 1021. first plug-in segment; 1022. second plug-in segment; 201. first finger-shaped arm; 2011. first massage finger; 2012. first hinge joint; 2013 first driving end; 202. second finger-shaped arm; 2021. second massage finger; 2022. second hinge joint; 2023. second driving end; 3. gap; 4. inner cavity of a part to be massaged; 5. supporting portion; 501. supporting block; 6. cross transmission assembly; 601. active end; 602. passive end; 603. third hinge joint; 604. transmission block; 7. eccentric drive assembly; 701. driving rail connection portion; 7011. driving handle; 7012. C-shaped snap fastener; 702. driving motor; 7021. driving plate; 801. eccentric driving rail; 8011. waist-shaped groove; 8012. convex guiding rail rib; 901. transmission hole; 902. hinge hole; 903. rotating plate; 1001. C-shaped snap connection portion; 1002. convex rib; 11. first vibration device; 1101. first vibration motor; 12. auxiliary massage structure; 1201. second vibration device; 12011. second vibration motor; 1202. negative-pressure sucking massage structure; 12021. negative-pressure sucking port; 12022. negative-pressure cavity; 12023. negative-pressure piston; 12024. negative-pressure motor; 12025. first opening; 12026. second opening; 1203. reciprocating movement massage structure; 12031. linear motor; 13. massage head; 1301. massage synapse; and 14. power supply unit.

### DETAILED DESCRIPTIONS OF THE EMBODIMENTS

The technical solutions of embodiments of the present disclosure will be described below clearly and comprehensively in conjunction with accompanying drawings of the embodiments of the present disclosure. Apparently, the embodiments described are merely some embodiments rather than all embodiments of the present disclosure. All the other embodiments obtained by those of ordinary skill in the art based on the embodiments in the present disclosure without creative efforts shall fall within the scope of protection of the present disclosure.

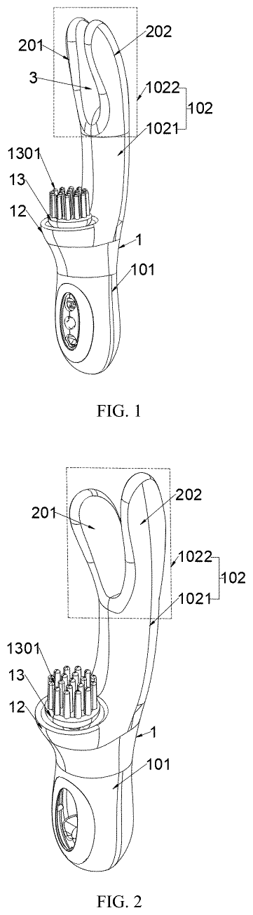

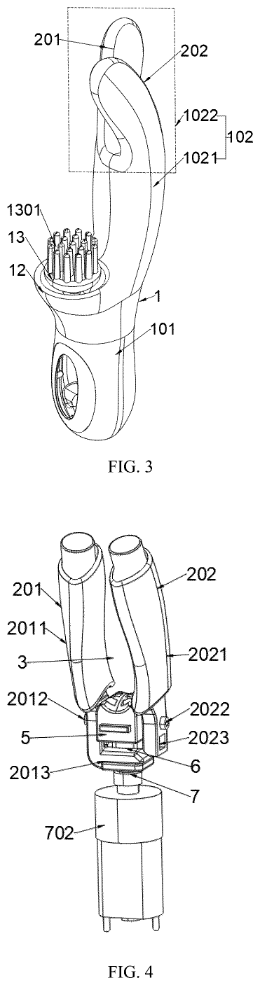

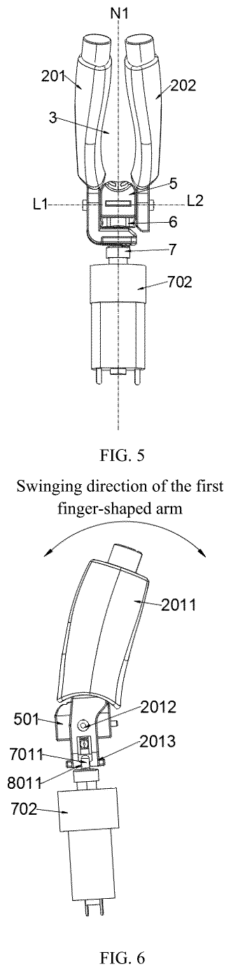

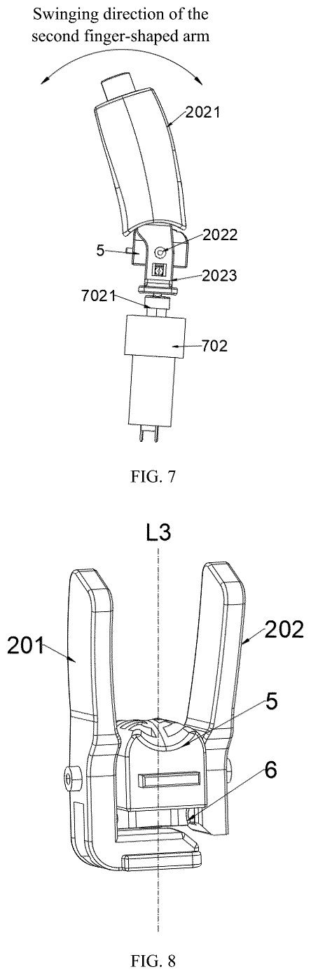

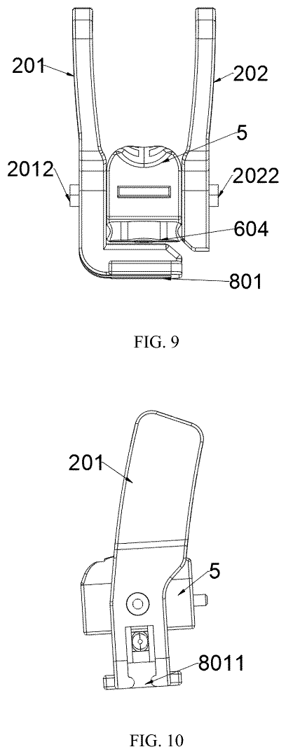

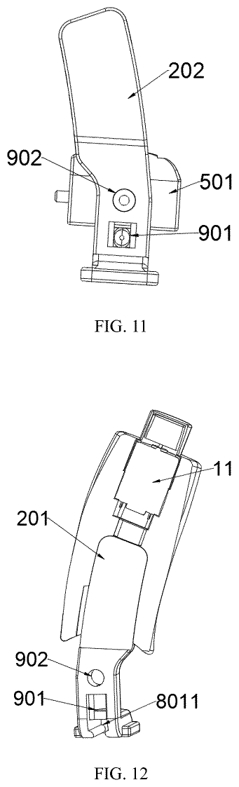

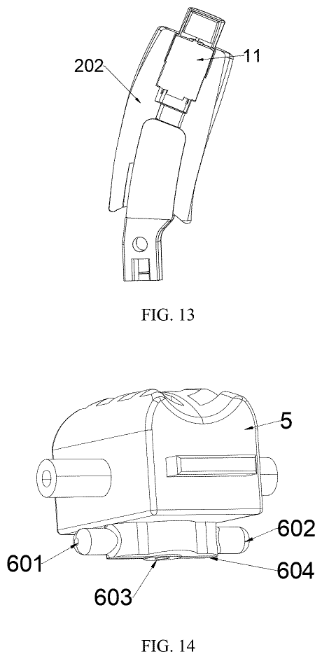

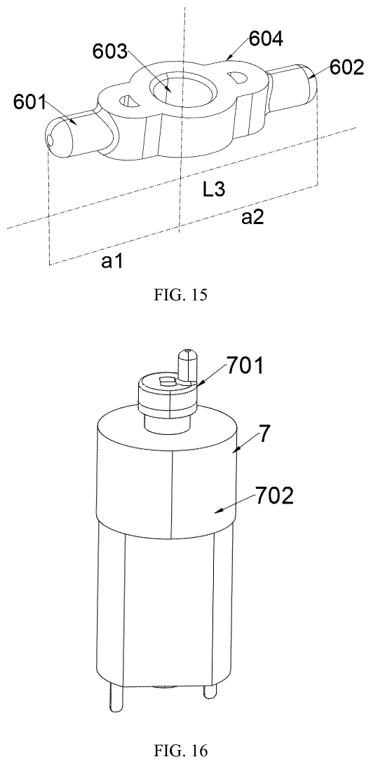

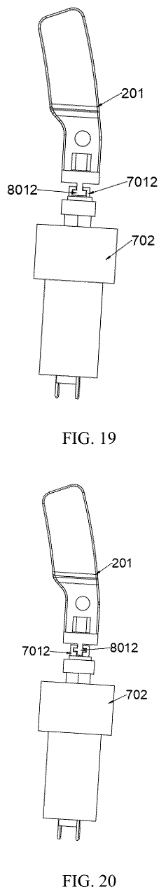

With reference to FIGS. 1-24, specific embodiments provided by the present disclosure are as follows:
as shown in FIGS. 1-3, a first embodiment of the present disclosure provides a crossed-finger swinging massage structure, including:
a wand-shaped main body 1 having a hand-held section 101 and a massage section 102;
the massage section 102 is adapted to be plugged into an inner cavity 4 of a part to be massaged;
where the massage section 102 includes a first plug-in segment 1021 and a second plug-in segment 1022;
the first plug-in segment 1021 is a solid rod-shaped structure;
the second plug-in segment 1022 is composed of a first finger-shaped arm 201 and a second finger-shaped arm 202 that are symmetrical about an axis N1;
further, a through gap 3 exists between the first finger-shaped arm 201 and the second finger-shaped arm 202, such that the first finger-shaped arm 201 and the second finger-shaped arm 202 exhibit a dual-finger structure form;
further, the axis N1 is an axis of the massage section 102; and
the first finger-shaped arm 201 and the second finger-shaped arm 202 can be controlled by driving force to swing in a crossed manner in the inner cavity 4 of the hole-shaped part to be massaged, so as to produce squeezing or tapping massage effects on a side wall surface of the inner cavity 4 of the hole-shaped part to be massaged.

In this embodiment, it is further found that:
first, the plug-in massage structure in the prior art produce relatively gentle stimulation to the inner cavity 4 (that is, a vagina) of the hole-shaped part to be massaged, the reason is that a telescopic massage structure, a kneading massage structure and a scraping massage structure are all make relatively small deformation degree of a wall surface of the inner cavity; and moreover, a size of each of the above massage structure is limited due to a relatively small size of the inner cavity, especially for the kneading massage structure, a size of a massage head thereof is relatively small, making the wall surface of the inner cavity difficult to have great deformation, such that the massage stimulation sensation felt by a user is poor; and
on this basis, an objective of this embodiment is to provide a massage structure capable of allowing a relatively great deformation of the inner cavity 4 of the hole-shaped part to be massaged, so as to improve stronger massage stimulation sensation felt by the user.

Specifically, the hand-held section 101 of the wand-shaped main body 1 is configured to be held by the user to facilitate operation. Further, an interior of the hand-held section 101 is a cavity structure for loading a power supply unit 14.

The wand-shaped main body 1 is provided with the massage section 102. According to the needs of the user, the massage section 102 can be completely plugged into the inner cavity 4 of the hole-shaped part to be massaged, or partially plugged into the inner cavity 4 of the hole-shaped part to be massaged. Further, the massage section 102 is divided into the first plug-in segment 1021 and the second plug-in segment 1022,
where first plug-in segment 1021 is closer to the hand-held section 101, and presents a solid rod-shaped structure; and the second plug-in segment 1022 is away from the hand-held section 101 and is composed of the first finger-shaped arm 201 and the second finger-shaped arm 202. The finger-shaped arm refers to an arm body that exhibits an approximate finger shape. Further, the first finger-shaped arm 201 and the second finger-shaped arm 202 are separated by the through gap 3, such that the first finger-shaped arm and the second finger-shaped arm represent mutually independent forms, and both of them can constitute a dual-finger structure.

On the basis of the above, when the driving force is exerted on the first finger-shaped arm 201 and/or the second finger-shaped arm 202, the first finger-shaped arm 201 and the second finger-shaped arm 202 can swing in a crossed manner, that is, the first finger-shaped arm and the second finger-shaped arm can go deep into the inner cavity 4 of the hole-shaped part to be massaged, and can massage and stimulate the inner cavity 4 of the hole-shaped part to be massaged in a crossed swinging manner, so as to ensure that massage stimulation effects are significantly improved.

As shown in FIGS. 1-3, the crossed swinging specifically refers to the situation that the first finger-shaped arm 201 and the second finger-shaped arm 202 perform swinging actions with opposite swinging directions, and the swinging directions of the first finger-shaped arm and the second finger-shaped arm are parallel. Further, the first finger-shaped arm 201 and the second finger-shaped arm 202 have the following three positions:
an initial position: projections of the first finger-shaped arm 201 and the second finger-shaped arm 202 on a plane where the axis N1 is located are completely coincident. It can be understood that circumferential wall surfaces of the first finger-shaped arm 201 and the second finger-shaped arm 202 extend, and are connected to form a rod-shaped structure capable of forming the second plug-in segment 1022. It is foreseeable that radial dimensions of the first finger-shaped arm 201 and the second finger-shaped arm 202 in an initial position state are relatively small, such that the second plug-in segment 1022 can be plugged into the hole-shaped part to be massaged.

A first extreme position: refers to a position that the first finger-shaped arm 201 and the second finger-shaped arm 202 are driven by the driving force to swing to positions of their respective maximum swing angles. The first finger-shaped arm 201 and the second finger-shaped arm 202 form a V shape. In the first extreme position, the radial dimensions of the first finger-shaped arm 201 and the second finger-shaped arm 202 are significantly increased to provide a relatively large pressure to the inner cavity 4 of the hole-shaped part to be massaged, such that greater deformation thereof is formed, and significant massage stimulation effects are finally produced.

A second extreme position: refers to a position that the first finger-shaped arm 201 and the second finger-shaped arm 202 swing to positions of maximum swing angles in a direction opposite to the first extreme position, proving the same technical effects as those of the first extreme position.

It can be seen that the first finger-shaped arm 201 and the second finger-shaped arm 202 are transitioned from the initial position to the first extreme position, and swing is switched between the first extreme position and the second extreme position, such that a radial dimension of the second plug-in segment 1022 can be significantly improved, the radial dimension is changed dynamically, and the circumferential wall surfaces of the first finger-shaped arm 201 and the second finger-shaped arm 202 can provide tapping or squeezing massage stimulation effects on the inner cavity 4 of the hole-shaped part to be massaged, such that the user can feel stronger stimulation sensation. Of course, when the first finger-shaped arm 201 and the second finger-shaped arm 202 are driven by the driving force to swing at a faster frequency, tapping massage effects will be produced, otherwise, squeezing massage effects will be produced.

In summary, the crossed-finger swinging massage structure provided in this embodiment at least:
first, it provides a cross-swinging massage form capable of entering the inner cavity 4 of the hole-shaped part to be massaged to cause the wall surface of the inner cavity to be greatly deformed, such that the user can feel stronger stimulation sensation; and
second, the cross-swinging massage form of the first finger-shaped arm 201 and the second finger-shaped arm 202 significantly increases the radial dimension of the second plug-in segment 1022, and the radial dimension is changed dynamically, such that greater squeezing or tapping acting force is exerted on the wall surface of the inner cavity, and stimulation sensation is significantly increased.

As shown in FIGS. 4-14, a second embodiment of the present disclosure provides a crossed-finger swinging massage structure, and on the basis of the first embodiment, the first finger-shaped arm 201 has a first massage finger 2011, a first hinge joint 2012, and a first driving end 2013;
the second finger-shaped arm 202 has a second massage finger 2021, a second hinge joint 2022 and a second driving end 2023;
a supporting portion 5;
a cross transmission assembly 6 having an active end 601, a passive end 602, and a third hinge joint 603;
an eccentric drive assembly 7 having a driving rail connection portion 701 and a driving motor 702;
where the first massage finger 2011 and the second massage finger 2021 are disposed in parallel to form a parallel dual-finger structure;
the first finger-shaped arm 201 and the supporting portion 5 are hinged to the first hinge joint 2012, the second finger-shaped arm 202 and the supporting portion 5 are hinged to the second hinge joint 2022, and the cross transmission assembly 6 and the supporting portion 5 are hinged to the third hinge joint 603;
the first massage finger 2011 can swing around an axis L1 at the first hinge joint 2012, the second massage finger 2021 can swing around an axis L2 at the second hinge joint 2022, and the cross transmission assembly 6 can swing around an axis L3 at the third hinge joint 603;
where the axis L1 is coaxial with the axis L2, and the axis L3 is perpendicular to the axis L1;
the first driving end 2013 is provided with an eccentric driving rail 801 parallel to the axis L1, and the driving rail connecting portion 701 is movably connected to the eccentric driving rail 801;
the driving rail connecting portion 701 is disposed at an eccentric position where the driving motor 702 rotates, and the first finger-shaped arm 201 swings around the axis L1 in response to the driving rail connecting portion 701 rotating in an eccentric manner; and
the active end 601 of the cross transmission assembly 6 is connected to the first driving end 2013, and the passive end 602 thereof is connected to the second driving end 2023 to form a seesaw reversing transmission structure, such that the first massage finger 2011 and the second massage finger 2021 swing in a crossed manner.

In this embodiment, a specific structure that the first finger-shaped arm 201 and the second finger-shaped arm 202 swing in a crossed manner is provided.

In the prior art, a driving dual-finger structure usually adopts the same driving mechanism (that is, a motor) to drive the two finger-shaped arms to swing, such that the structure needs to simultaneously provide the two finger-shaped arms with power corresponding to resisting static inertia (which means that each finger-shaped arm is converted from a static state to a moving state) at the moment that a driving mechanism is started, and also needs to simultaneously provide the two finger-shaped arms with power corresponding to counteraction of friction force (which means the friction force between each of the finger-shaped arms and the part to be massaged) of the two finger-shaped arms; and further, startup power of the driving mechanism also needs to be 3-5 times of rated power thereof, to ensure that the two finger-shaped arms are capable of performing movement effectively. Therefore, the above problem causes the driving mechanism to require greater rated power, but when power resources are limited, that is, a massager cannot be assembled with a driving mechanism with the greater rated power due to the limited space size, a response speed of the massage action performed by the two finger-shaped arms is limited.

On this basis, this embodiment makes the following optimization:
the driving motor 702 is connected to the eccentric driving rail 801 of the first driving end 2013 of the first finger-shaped arm 201 through a driving connecting portion, that is, the driving force provided by the driving motor 702 is only used for driving the first finger-shaped arm 201, without being used for driving the second finger-shaped arm 202, that is, such that the first finger-shaped arm 201 is driven to move independently, the driving force only needs to resist the static inertia of the first finger-shaped arm 201 (referring to kinetic energy required to switch the first finger-shaped arm 201 from a static state to a swing state) and friction force after movement (referring to resistance provided by the inner cavity 4 of the hole-shaped part to be massaged), such that startup power of the driving motor 702 is significantly reduced, and when the power resources are limited, power can be allocated reasonably, thereby avoiding waste of the power resources; and
the first finger-shaped arm 201 and the second finger-shaped arm 202 are connected by the cross transmission assembly 6, that is, after the first finger-shaped arm 201 swings, the active end 601 of the cross transmission assembly 6 is forced to move passively, which can be considered that the active end 601 collects swing force of the first finger-shaped arm 201 and transmits the swing force to the passive end 602, and the passive end 602 exerts the swing force on the second finger-shaped arm 202, thereby causing the second finger-shaped arm 202 to swing. Further, the formed seesaw reversing transmission structure specifically refers to that swinging directions of the active end 601 and the passive end 602 are opposite, such that the first finger-shaped arm 201 and the second finger-shaped arm 202 can swing in a crossed manner.

It can be seen that when the driving motor 702 is started up, the first finger-shaped arm 201 and the second finger-shaped arm 202 have different startup timings, that is, the second finger-shaped arm 202 moves only after the first finger-shaped arm 201 moves, in such a way, the driving motor 702 only needs to resist the static inertia and the friction force of the first finger-shaped arm 201 at the moment of startup, such that the power thereof is fully exerted thereon, the dual-finger structure (referring to a structure having the first finger-shaped arm 201 and the second finger-shaped arm 202) is capable of quickly responding to the action of the driving force, featuring rapid response and reasonable distribution of power, and the first finger-shaped arm 201 and the second finger-shaped arm 202 finally realize the function of quick action under the condition of limited power resources; and
third, amplitude and frequency of swing actions the first finger-shaped arm 201 are relatively higher than amplitude and frequency of swing actions of the second finger-shaped arm 202, resulting in a difference in swinging actions, and the difference further leads to different massage simulation effects on the inner cavity of the hole-shaped part to be massaged.

In one specific implementation, the cross transmission assembly 6 includes a transmission block 604, two end faces of the transmission block 604 are formed with the active end 601 and the passive end 602, and the active end 601 and the passive end 602 are represented as transmission shafts. A transmission hole 901 is formed on the first driving end 2013 and the second driving end 2023, and the transmission shaft is coupled to the transmission hole 901. The third hinge joint 603 is disposed at a center of the transmission block 604, and the third hinge joint 603 is represented as a third hinge shaft and is hinged to the supporting portion 5.

In one specific implementation, the first finger-shaped arm 201 is an L-shaped structure, and the second finger-shaped arm 202 is a straight plate structure.

In one specific implementation, the supporting portion 5 includes a supporting block 501, two end faces of the supporting block 501 are formed with the first hinge joint 2012 and the second hinge joint 2022, and the first hinge joint 2012 and the second hinge joint 2022 are represented as hinge shafts. Hinge holes 902 are formed at positions corresponding to the first hinge joint 2012 and the second hinge joint 2022 of the first finger-shaped arm 201 and the second finger-shaped arm 202, and the hinge shafts are hinged to the hinge holes 902.

In one specific implementation, when the first massage finger 2011 and the second massage finger 2021 are in parallel positions, a circumferential outer surface of the dual-finger structure is an approximately cylindrical structure, and the approximately cylindrical structure is suitable for being plugged into the hole-shaped part to be massaged to produce squeezing or tapping massage effects on the side wall surface of the inner cavity of the hole-shaped part to be massaged. Specifically, the parallel positions mentioned in the specific implementation are the initial position mentioned above. In the position, circumferential outer surfaces of the first massage finger 2011 and the second massage finger 2021 form an approximately cylindrical structure, to facilitate plugging into the inner cavity 4 of the hole-shaped part to be massaged.

In one specific implementation, the first massage finger 2011 and the second massage finger 2021 of the crossed-finger swinging massage structure are bent in a swinging direction; and/or
the first massage finger 2011 and the second massage finger 2021 of the crossed-finger swinging massage structure are bent in a direction perpendicular to the swinging direction.

In one specific implementation, the wand-shaped main body 1 of the crossed-finger swinging massage structure is a linear wand-shaped main body 1 or an arc-shaped wand-shaped main body 1.

As shown in FIGS. 12-16, a third embodiment of the present disclosure provides a crossed-finger swinging massage structure, and on the basis of the first embodiment, the eccentric driving rail 801 is a waist-shaped groove 8011, and the driving rail connecting portion 701 is a driving handle 7011 matching the waist-shaped groove 8011.

In this embodiment, the waist-shaped groove is formed on the first driving end 2013 of the first finger-shaped arm 201. The driving handle 7011 is connected to a driving plate 7021 of the driving motor 702 in an eccentric connection manner.

When in specific use, the driving motor 702 is started up to drive the driving plate 7021 to rotate, the driving handle 7011 is accordingly driven to rotate in an eccentric manner, and the driving handle 7011 drives the waist-shaped groove to move, such that the first finger-shaped arm 201 is driven to swing around the axis L1.

Specifically, a circumferential wall surface of the driving handle 7011 is in contact with an inner wall surface of the waist-shaped groove, such that the first finger-shaped arm 201 is driven to swing. Therefore, during eccentric rotation of the driving handle 7011, the circumferential wall surface thereof in contact with the inner wall surface of the waist-shaped groove changes. For example, in a cross-sectional view of the driving handle 7011, the circumferential wall surface thereof can be divided into two semicircles along an axis of the driving handle. When one semicircle is in contact with the inner wall surface of the waist-shaped groove, the first finger-shaped arm 201 can be driven to swing along one of the strokes in the swinging direction. When the other semicircle is in contact with the inner wall surface of the waist-shaped groove, the first finger-shaped arm 201 can be driven to swing along the other stroke in the swinging direction, such that a reciprocating swing process of the first finger-shaped arm 201 is formed.

In one specific implementation, the driving handle 7011 is a cylindrical structure, such as a cylindrical shape. A value range of a diameter thereof is 2 mm to 4 mm, and correspondingly, a value range of a groove width of the waist-shaped groove is 4 mm to 6 mm.

As shown in FIGS. 18-20, a fourth embodiment of the present disclosure provides a crossed-finger swinging massage structure, the eccentric driving rail 801 is a convex guiding rail rib 8012, and the driving rail connection portion 701 is a C-shaped snap fastener 7012 in snap-in connection with the convex guiding rail rib 8012.

In the above embodiment (the third embodiment), it is further found that:
first, since the crossed-finger swinging massage structure provided in this embodiment is plug-in type and needs to bear a certain load, the driving handle 7011 has a physical size, that is, a diameter size of a certain value. As described above, a plug-in massager itself is limited in size, and the driving handle 7011 is configured to switch the circumferential wall surface of different areas to be in contact with the inner wall surface of the waist-shaped groove to achieve the swing reversing of the first finger-shaped arm 201. That is to say, the diameter size of the driving handle 7011 is a deterioration parameter, having an adverse impact of increasing the size under the condition of limited size. That is, the larger the diameter of the driving handle 7011 is, the size of the plug-in massager will corresponding increase, which is mutually exclusive with the foregoing conditions;
second, a certain gap exists between the driving handle 7011 and the waist-shaped groove. A size of the gap will also have a proportion under the already limited size, resulting in a reduction in a proportion of an effective size of the size and an increase in the proportion of an ineffective size thereof. Moreover, the gap can cause a certain collision feeling when the waist-shaped groove is in contact with the driving handle 7011, and the collision feeling will also be reflected in the cross swing of the first finger-shaped arm 201 and the second finger-shaped arm 202, such that a certain degree of shaking is generated, and the massage stimulation effects felt by the user is affected; and
third, since the size is limited, the diameter size of the driving plate 7021 will inevitably not be too large, which will result in eccentric rotation of the driving handle 7011, and drive the waist-shaped groove to displace a relatively small distance, and swing amplitudes of the first finger-shaped arm 201 and the second finger-shaped arm 202 are significantly reduced, therefore, it is impossible to provide stronger squeezing force or tapping force.

On this basis, when the eccentric driving rail 801 is the convex guiding rail rib 8012, and the driving rail connecting portion 701 is the C-shaped snap fastener 7012, under the condition that the size is limited, it can have:
first, a thickness of the convex guiding rail rib 8012 can be thin, and a thickness of a cap of the C-shaped snap fastener 7012 can also be thin. The reason is that, the form adopts a driving mode that the cap of the C-shaped snap fastener 7012 is in sliding contact with an outer wall surface of the convex guiding rail rib 8012, and when the driving plate 7021 of the driving motor 702 rotates, the C-shaped snap fastener 7012 is driven (the C-shaped snap fastener 7012 is rotationally connected to the driving plate 7021, such as being connected through a rotating plate 903, the rotating plate 903 is eccentrically hinged to the driving plate 7021, and the C-shaped snap fastener 7012 is connected to the rotating plate 903) to rotate eccentrically, such that the C-shaped snap fastener 7012 drives the convex guiding rail rib 8012 to make displacement, and the first finger-shaped arm 201 is driven to swing. It can be seen from the above process that the thickness of the convex guiding rail rib 8012 and the size of the cap thickness of the C-shaped snap fastener 7012 will not affect the driving process, therefore, such that a problem of the limited size can be solved by reducing the thickness of the convex guiding rail rib and the C-shaped snap fastener, thereby ensuring that the size can be reasonably planned and distributed;
second, when the thickness of the convex guiding rail rib 8012 and the cap thickness of the C-shaped snap fastener 7012 can be reduced, the C-shaped snap fastener 7012 can be further installed at a position closer to an edge of the driving plate 7021, that is, an eccentricity of the C-shaped snap fastener 7012 will be improved, such that when the C-shaped snap fastener rotates eccentrically, the convex guiding rail rib 8012 can be driven make larger displacement, the swing amplitudes of the first finger-shaped arm 201 and the second finger-shaped arm 202 are remarkably improved, and the massage stimulation effects are accordingly improved; and
third, after the above two points are satisfied, heights of the C-shaped snap fastener 7012 and the convex guiding rail rib 8012 can be further increased, that is, a length of a power arm is increased, such that the driving force exerted on the first finger-shaped arm 201 and the second finger-shaped arm 202 becomes greater to effectively resist the resistance (referring to the resistance of the inner cavity 4 of the hole-shaped part to be massaged to the first finger-shaped arm 201 and the second finger-shaped arm 202).

In one specific implementation, a distance a1 from an end portion of the active end 601 to the third hinge joint 603 is less than a distance a2 from an end portion of the passive end 602 to the third hinge joint 603. The reason is that a1 is equivalent to the power arm, and a2 is equivalent to a resistance arm, and the swing amplitude of the second finger-shaped arm 202 connected to the resistance arm is amplified by increasing a length of the resistance arm, such that the squeezing force or tapping force of the second finger-shaped arm 202 on the inner cavity 4 of the hole to be massaged is increased.

In one specific implementation, a cross section of the convex guiding rail rib 8012 is a T-shaped structure or a cross-shaped structure, the reason is that when the thickness of the convex guiding rail rib 8012 is small, overall strength of the convex guiding rail rib will be limited, that is, the load capacity thereof is significantly reduced. Therefore, when the convex guiding rail rib is the T-shaped or cross-shaped structure, the strength of the convex guiding rail rib 8012 can be significantly improved, that is, the load capacity in a thickness direction of the convex guiding rail rib 8012 is increased.

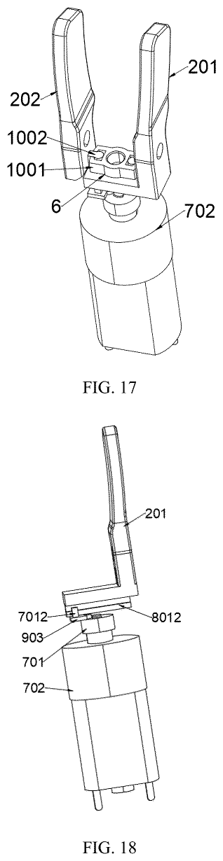

As shown in FIG. 17, a fifth embodiment of the present disclosure provides a crossed-finger swinging massage structure, the active end 601 and the passive end 602 are C-shaped snap connecting portions 1001, and the first driving end 2013 and the second driving end 2023 have convex ribs 1002 connected to the C-shaped snap connecting portions 1001.

In this embodiment, it is further found that when the active end 601 and the passive end 602 adopt the form of the transmission shaft, a gap still exists between the transmission shaft and the transmission hole 901. A size of the gap will increase an overall dimension of the plug-in massager, resulting in that a connection of the active end 601 and the passive end 602 to the first driving end 2013 and the second driving end 2023 is not tight, such that the first finger-shaped arm 201 and the second finger-shaped arm 202 will shake.

On this basis, the connection form of the transmission shaft and the transmission hole 901 needs to be changed, therefore, a form that the C-shaped snap connection portions 1001 are connected to the convex ribs 1002 is adopted, such that the aforesaid end portions can be tightly connected in spite of small dimensions, so as to avoid the generation of gaps and improve the swing stability of the first finger-shaped arm 201 and the second finger-shaped arm 202.

In one specific implementation, end portions of the first finger-shaped arm 201 and the second finger-shaped arm 202 are cavity structures, and a first vibration device 11, such as a first vibration motor 1101, is installed inside the cavity structure to produce vibrating massage effects.

A sixth embodiment of the present disclosure provides a crossed-finger swinging massager, including:
the crossed-finger swinging massage structure according to any one of the above embodiments; and
an auxiliary massage structure 12, where the auxiliary massage structure 12 is formed by branching the wand-shaped main body 1 of the crossed-finger swinging massage structure, so as to provide massage effects on an outer surface of the hole-shaped part to be massaged.

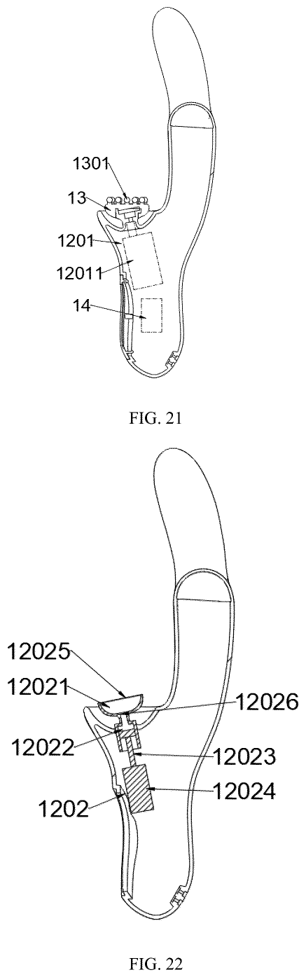

As shown in FIG. 21, in one specific implementation, the auxiliary massage structure 12 is a vibrating massage structure. Specifically, a second vibration device 1201, such as a second vibration motor 12011, is assembled on the hand-held section 101 of the wand-shaped main body 1, and a massage head 13 is assembled on a driving end of the second vibration motor 12011. The second vibration motor 12011 drives the massage head 13 to vibrate, so as to produce vibrating massage stimulation effects on the outer surface of the hole-shaped part to be massaged, such as a clitoris or labia.

As shown in FIG. 22, in one specific implementation, the auxiliary massage structure 12 is a negative-pressure sucking massage structure 1202. Specifically, the negative-pressure sucking massage structure 1202 includes a negative-pressure sucking port 12021, a negative-pressure cavity 12022, a negative-pressure piston 12023, and a negative-pressure motor 12024, where negative-pressure sucking port 12021 has a first opening 12025 and a second opening 12026, the first opening 12025 is configured to wrap the outer surface of the hole-shaped part to be massaged, and the second opening 12026 is configured to be communicated with the negative-pressure cavity 12022. Further, the negative-pressure piston 12023 is slidably connected inside the negative-pressure cavity 12022, and is driven by the negative-pressure motor 12024 to perform piston movements inside the negative-pressure cavity 12022, such that negative-pressure sucking massage simulation of the first opening 12025 is produced.

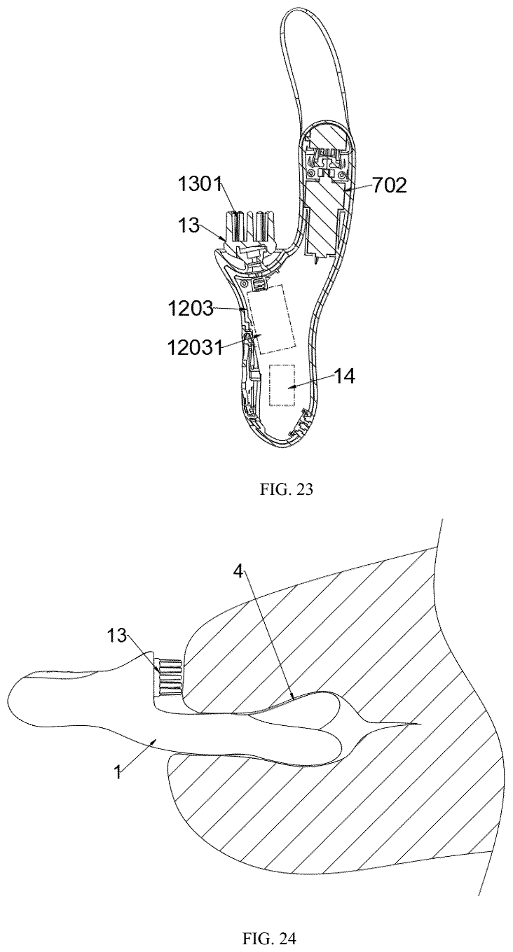

As shown in FIG. 23, in one specific implementation, the auxiliary massage structure 12 is a reciprocating movement massage structure 1203. Specifically, a reciprocating movement device can include a linear motor 12031 and the massage head 13, and the linear motor 12031 drives the massage head 13 to perform reciprocating linear movements to produce tapping or knocking massage stimulation.

As shown in FIG. 24, in one specific implementation, a plurality of massage synapses 1301 are formed on a surface of the massage head 13, and the massage synapses 1301 can be elastic balls, blocks, or strips. When the massage head 13 is driven by the second vibration motor 12011, the plurality of massage synapses 1301 in the form of elastic balls, blocks, or strips act on an outer surface of the hole-shaped part to be massaged to produce scrapping or friction massage stimulation effects.

In the description of the embodiments of the present disclosure, it should be noted that, unless otherwise explicitly specified and defined, the terms “mounting”, “connecting”, “connection” and “assembly” should be understood in a broad sense, for example, they may be a fixed connection, a detachable connection, or an integrated connection; and may be a direct connection, or an indirect connection via an intermediate medium, or communication inside two elements. For those of ordinarily skilled in the art, specific meanings of the above terms in the present disclosure could be understood according to specific circumstances.

In the description of the embodiments of the present disclosure, specific feature, structure, material or characteristics described may be combined in a suitable manner in any one or more embodiments or examples.

Although the embodiments of the present disclosure have been illustrated and described, it should be understood that those of ordinary skill in the art may make various changes, modifications, replacements and variations to the above embodiments without departing from the principle and spirit of the present disclosure, and the scope of the present disclosure is limited by the appended claims and their legal equivalents.

What is claimed is:

1. A crossed-finger swinging massage structure, comprising:
a wand-shaped main body having a hand-held section and a massage section;
the massage section is adapted to be plugged into an inner cavity of a hole-shaped part to be massaged; wherein
the massage section comprises a first plug-in segment and a second plug-in segment;
the first plug-in segment is a solid rod-shaped structure;
the second plug-in segment is composed of a first finger-shaped arm and a second finger-shaped arm that are symmetrical about an axis N1;
a through gap exists between the first finger-shaped arm and the second finger-shaped arm, such that the first finger-shaped arm and the second finger-shaped arm exhibit a dual-finger structure form;
the axis N1 is an axis of the massage section; and
the first finger-shaped arm and the second finger-shaped arm can be controlled by driving force to swing in a crossed manner in the inner cavity of the hole-shaped part to be massaged, so as to produce squeezing or tapping massage effects on a side wall surface of the inner cavity of the hole-shaped part to be massaged.

2. The crossed-finger swinging massage structure according to claim 1, wherein
the first finger-shaped arm has a first massage finger, a first hinge joint, and a first driving end;
the second finger-shaped arm has a second massage finger, a second hinge joint and a second driving end; and
the crossed-finger swinging massage structure further comprising:
a supporting portion;
a cross transmission assembly having an active end, a passive end, and a third hinge joint; and
an eccentric drive assembly having a driving rail connection portion and a driving motor; wherein
the first massage finger and the second massage finger are disposed in parallel to form a parallel dual-finger structure;
the first finger-shaped arm and the supporting portion are hinged to the first hinge joint, the second finger-shaped arm and the supporting portion are hinged to the second hinge joint, and the cross transmission assembly and the supporting portion are hinged to the third hinge joint;
the first massage finger can swing around an axis L1 at the first hinge joint, the second massage finger can swing around an axis L2 at the second hinge joint, and the cross transmission assembly can swing around an axis L3 at the third hinge joint;
the axis L1 is coaxial with the axis L2, and the axis L3 is perpendicular to the axis L1;
the first driving end is provided with an eccentric driving rail parallel to the axis L1, and the driving rail connecting portion is movably connected to the eccentric driving rail;
the driving rail connecting portion is disposed at an eccentric position where the driving motor rotates, and the first finger-shaped arm swings around the axis L1 in response to the driving rail connecting portion rotating in an eccentric manner; and
the active end of the cross transmission assembly is connected to the first driving end, and the passive end thereof is connected to the second driving end to form a seesaw reversing transmission structure, such that the first massage finger and the second massage finger can swing in a crossed manner.

3. The crossed-finger swinging massage structure according to claim 2, wherein
when the first massage finger and the second massage finger are in parallel positions, a circumferential outer surface of the dual-finger structure is an approximately cylindrical structure, and the approximately cylindrical structure is suitable for being plugged into the hole-shaped part to be massaged to produce squeezing or tapping massage effects on the side wall surface of the inner cavity of the hole-shaped part to be massaged.

4. The crossed-finger swinging massage structure according to claim 2, wherein
the eccentric driving rail is a waist-shaped groove, and the driving rail connecting portion is a driving handle matching the waist-shaped groove.

5. The crossed-finger swinging massage structure according to claim 2, wherein
the eccentric driving rail is a convex guiding rail rib, and the driving rail connection portion is a C-shaped snap fastener in snap-in connection with the convex guiding rail rib.

6. The crossed-finger swinging massage structure according to claim 5, wherein
a distance a1 from an end portion of the active end to the third hinge joint is less than a distance a2 from an end portion of the passive end to the third hinge joint.

7. The crossed-finger swinging massage structure according to claim 5, wherein
a cross section of the convex guiding rail rib is a T-shaped structure or a cross-shaped structure,

8. The crossed-finger swinging massage structure according to claim 6, wherein
the active end and the passive end are C-shaped snap connecting portions, and the first driving end and the second driving end have convex ribs connected to the C-shaped snap connecting portions.

9. The crossed-finger swinging massage structure according to claim 1, wherein
a first vibration device is installed inside each of the first finger-shaped arm and the second finger-shaped arm.

10. A crossed-finger swinging massager, comprising:
the crossed-finger swinging massage structure according to claim 1, and
an auxiliary massage structure, wherein the auxiliary massage structure is formed by branching the wand-shaped main body of the crossed-finger swinging massage structure, so as to provide massage effects on an outer surface of the hole-shaped part to be massaged.

11. The crossed-finger swinging massager according to claim 10, wherein
the auxiliary massage structure is a vibrating massage structure, a negative-pressure sucking massage structure, or a reciprocating movement massage structure.

12. The crossed-finger swinging massager according to claim 11, wherein
when the auxiliary massage structure is the vibrating massage structure, or the reciprocating movement massage structure, the auxiliary massage structure is equipped with a massage head; and
the massage head has a plurality of massage synapses protruding from a surface of the massage head.

13. The crossed-finger swinging massager according to claim 12, wherein
the massage synapses are ball-shaped, block-shaped, or strip-shaped.

14. The crossed-finger swinging massager according to claim 10, wherein
the first massage finger and the second massage finger of the crossed-finger swinging massage structure are bent in a swinging direction; and/or
the first massage finger and the second massage finger of the crossed-finger swinging massage structure are bent in a direction perpendicular to the swinging direction.

15. The crossed-finger swinging massager according to claim 10, wherein
the wand-shaped main body of the crossed-finger swinging massage structure is a linear wand-shaped main body or an arc-shaped wand-shaped main body.
